(19) United States
(12) Patent Application Publication
(10) Pub. No.: US 2023/0026824 A1
(43) Pub. Date: Jan. 26, 2023

(54) MEMORY SYSTEM FOR ACCELERATING GRAPH NEURAL NETWORK PROCESSING

(71) Applicant: T-head (Shanghai) Semiconductor Co., Ltd., Shangai (CN)

(72) Inventors: Fei XUE, Sunnyvale, CA (US); Yangjie ZHOU, Shanghai (CN); Lide DUAN, Sunnyvale, CA (US); Hongzhong ZHENG, Los Gatos, CA (US)

(21) Appl. No.: 17/866,304

(22) Filed: Jul. 15, 2022

(30) Foreign Application Priority Data
Jul. 23, 2021 (CN) 202110835596.7

(51) Int. Cl. G06F 12/0868; G06F 12/0862

(52) U.S. Cl. CPC G06F 12/0868; G06F 12/0862; G06F 2212/301

(57) ABSTRACT

A memory system for accelerating graph neural network processing can include an on-host chip memory to cache data needed for processing a current root node. The system can also include a volatile memory interface between the host and non-volatile memory. The volatile memory can be configured to save one or more sets of next root nodes, neighbor nodes and corresponding attributes. The non-volatile memory can have sufficient capacity to store the entire graph data. The non-volatile memory can also be configured to pre-arrange the sets of next root nodes, neighbor nodes and corresponding attributes for storage in the volatile memory.

### CROSS-REFERENCE TO RELATED APPLICATIONS

This application claims priority to Chinese Patent Application No. 202110835596.7 filed Jul. 23, 2021.

### BACKGROUND OF THE INVENTION

Graph databases are utilized in a number of applications ranging from online shopping engines, social networking, knowledge graphs, recommendation engines, mapping engines, failure analysis, network management, life science, search engines, and the like. Graph databases can be used to determine dependencies, clustering, similarities, matches, categories, flows, costs, centrality and the like in large data set.

A graph database uses a graph structure with nodes, edges and attributes to represent and store data for semantic queries. The graph relates data items to a collection of nodes, edges and attributes. The nodes, which can also be referred to as vertexes, can represent entities, instance or the like. The edges can represent relationships between nodes, and allow data to be linked together directly. Attributes can be information germane to the nodes or edges. Graph databases allow simple and fast retrieval of complex hierarchical structures that are difficult to model in relational systems. A graph (G) can include a plurality of vertices (V) 105-120 coupled by one or more edges (E) 125-130 as illustrated in FIG. 1., and can be represented as G=(V,E). On a high level, the representation vector of a node can be computed by recursive aggregation and transformation of representation vectors of a root vector's neighbor nodes. One issue with graph neural networks (GNN) training or influence in hardware implementations is the large size of the graph data. In some implementation, the graph data can be 10 terabytes (TB) or more. Conventional GNNs can be implemented in a distributed central processing or graphic processing unit (CPU/GPU) systems, wherein the large size of the graph data is first loaded into dynamic access random access memories (DRAMs) located on distributed servers. In the conventional systems there are two major issues. First, system latency can be affected by data sampling through the distributed DRAMs. For example, data sampling latency can be 10× higher than computation latency. Second, the high cost of DRAM and the distribution system can also create issues.

Graph processing typically incurs large processing utilization and large memory access bandwidth utilization. Accordingly, there is a need for improved graph processing platforms that can reduce latency associated with the large processing utilization, improve memory bandwidth utilization, and the like.

### SUMMARY OF THE INVENTION

The present technology may best be understood by referring to the following description and accompanying drawings that are used to illustrate embodiments of the present technology directed toward memory systems for accelerating graph neural network (GNN) processing.

In one embodiment, a computing system for processing graph data can include a volatile memory, a host communicatively coupled to the volatile memory and a non-volatile memory communicatively coupled to the host and the volatile memory. The host can include a prefetch control unit configured to request data for a plurality of root nodes. The non-volatile memory can be configured to store graph data. The non-volatile memory can include a node pre-arrange control unit configured to retrieve sets of root and neighbor nodes and corresponding attributes from the graph data in response to corresponding requests for root nodes. The node pre-arrange control unit can also be configured to write the sets of root and neighbor nodes and corresponding attributes to the volatile memory in a prearranged data structure.

In another embodiment, a memory hierarchy method for graph neural network processing can include requesting, by a host, data for a root node. A non-volatile memory can retrieve structure and attribute data for a set of a root node and corresponding neighbor nodes. The non-volatile memory can also write the structure and attribute data for the set of the root node and corresponding neighbor nodes to volatile memory in a prearranged data structure. The host can read the structure and attribute data for the set of the root node and corresponding neighbor nodes from the volatile memory into a cache of the host. The host can process the structure and attribute data for the set of the root node and corresponding neighbor nodes.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Embodiments of the present technology are illustrated by way of example and not by way of limitation, in the figures of the accompanying drawings and in which like reference numerals refer to similar elements and in which:

FIG. 1 illustrates an exemplary graph database, according to the conventional art.

FIG. 2 shows a graph neural network processing system, in accordance with aspects of the present technology.

FIGS. 3A and 3B show a memory hierarchy method for graph neural network processing, in accordance with aspects of the present technology.

FIG. 4 shows a non-volatile memory of a graph neural network processing system, in accordance with aspects of the present technology.

FIG. 5 shows a host and volatile memory of a graph neural network processing system, in accordance with aspects of the present technology.

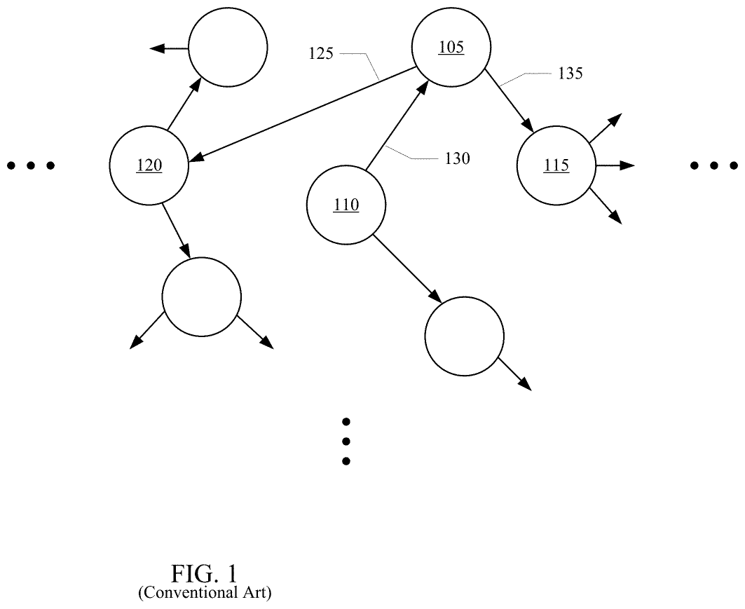

### DETAILED DESCRIPTION OF THE INVENTION

Reference will now be made in detail to the embodiments of the present technology, examples of which are illustrated in the accompanying drawings. While the present technology will be described in conjunction with these embodiments, it will be understood that they are not intended to limit the technology to these embodiments. On the contrary, the invention is intended to cover alternatives, modifications and equivalents, which may be included within the scope of the invention as defined by the appended claims. Furthermore, in the following detailed description of the present technology, numerous specific details are set forth in order to provide a thorough understanding of the present technology. However, it is understood that the present technology may be practiced without these specific details. In other instances, well-known methods, procedures, components, and circuits have not been described in detail as not to unnecessarily obscure aspects of the present technology.

Some embodiments of the present technology which follow are presented in terms of routines, modules, logic blocks, and other symbolic representations of operations on data within one or more electronic devices. The descriptions and representations are the means used by those skilled in the art to most effectively convey the substance of their work to others skilled in the art. A routine, module, logic block and/or the like, is herein, and generally, conceived to be a self-consistent sequence of processes or instructions leading to a desired result. The processes are those including physical manipulations of physical quantities. Usually, though not necessarily, these physical manipulations take the form of electric or magnetic signals capable of being stored, transferred, compared and otherwise manipulated in an electronic device. For reasons of convenience, and with reference to common usage, these signals are referred to as data, bits, values, elements, symbols, characters, terms, numbers, strings, and/or the like with reference to embodiments of the present technology.

It should be borne in mind, however, that these terms are to be interpreted as referencing physical manipulations and quantities and are merely convenient labels and are to be interpreted further in view of terms commonly used in the art. Unless specifically stated otherwise as apparent from the following discussion, it is understood that through discussions of the present technology, discussions utilizing the terms such as “receiving,” and/or the like, refer to the actions and processes of an electronic device such as an electronic computing device that manipulates and transforms data. The data is represented as physical (e.g., electronic) quantities within the electronic device's logic circuits, registers, memories and/or the like, and is transformed into other data similarly represented as physical quantities within the electronic device.

In this application, the use of the disjunctive is intended to include the conjunctive. The use of definite or indefinite articles is not intended to indicate cardinality. In particular, a reference to “the” object or “a” object is intended to denote also one of a possible plurality of such objects. The use of the terms “comprises,” “comprising,” “includes,” “including” and the like specify the presence of stated elements, but do not preclude the presence or addition of one or more other elements and or groups thereof. It is also to be understood that although the terms first, second, etc. may be used herein to describe various elements, such elements should not be limited by these terms. These terms are used herein to distinguish one element from another. For example, a first element could be termed a second element, and similarly a second element could be termed a first element, without departing from the scope of embodiments. It is also to be understood that when an element is referred to as being “coupled” to another element, it may be directly or indirectly connected to the other element, or an intervening element may be present. In contrast, when an element is referred to as being “directly connected” to another element, there are not intervening elements present. It is also to be understood that the term “and or” includes any and all combinations of one or more of the associated elements. It is also to be understood that the phraseology and terminology used herein is for the purpose of description and should not be regarded as limiting.

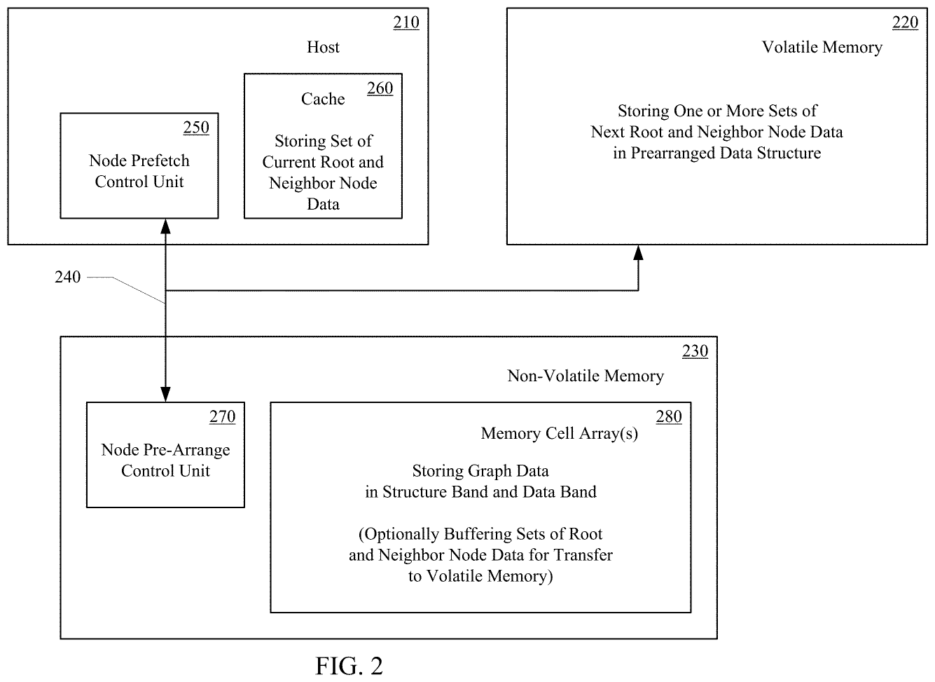

Referring to FIG. 2, a graph neural network (GNN) processing system, in accordance with aspects of the present technology, is shown. The GNN processing system 200 can include host 210, a volatile memory (VM) 220 and a non-volatile memory (NVM) 230 communicatively coupled together by one or more communication links 240. The host 210 can include one or more processing units, accelerators or the like (not shown), a node prefetch control unit 250 and a cache 260. In one implementation, the cache 260 can be static random-access memory (SRAM) or the like. The host 210 can include numerous other subsystem that are not germane to an understanding aspects of the present technology, and therefore are not described herein.

The volatile memory 220 can include one or more control units and one or more memory cell arrays (not shown). The one or more memory cell arrays of the volatile memory 220 can be organized in one or more channels, a plurality of blocks, a plurality of pages, and the like. In one implementation, the volatile memory 220 can be dynamic random-access memory (DRAM) or the like. The volatile memory 220 can include numerous other subsystem that are not germane to an understanding aspects of the present technology, and therefore are not described herein.

The non-volatile memory 230 can include a node pre-arrange control unit 270 and one or more memory cell arrays 280. The one or more memory cell arrays 280 of the non-volatile memory 230 can be organized in one or more channels, a plurality of blocks, a plurality of pages, and the like. In one implementation, the non-volatile memory 230 can be flash memory or the like. The non-volatile memory 230 can include numerous other subsystem that are not germane to an understanding aspects of the present technology, and therefore are not described herein. The non-volatile memory 230 can be configured to store graph data include a plurality nodes and associated node attributes.

The graph neural network (GNN) processing system can be configured to process graph data. In a graph, the data is arranged as a collection of nodes, edges and properties. The nodes can represent entities, instance, or the like and the edges can represent relationships between nodes and allow data to be linked together. Attributes can be information germane to the nodes and edges. Any nodes in the graph can be considered a root node for a given process performed on the graph data. These nodes directly connected to a given root node by a corresponding edge can be considered a first level neighbor node. Those nodes coupled to the given root node through a first level neighbor node by a corresponding edge can be considered a second level neighbor node, and so on. Processing on a given node may be performed on a set including the given node as the root node, one or more level of neighbor nodes of the root node, and corresponding attributes.

The node prefetch control unit 250 of the host 210 can be configured to request data for a plurality of root nodes from the non-volatile memory 230. The node pre-arrange control unit 270 of the non-volatile memory 230 can be configured to retrieve sets of root and neighbor node data for each of the requested root nodes. The node re-arrange control unit 270 can be configured to then write the sets of root and neighbor node data to the volatile memory 220 in a prearranged data structure. Optionally, sets of root and neighbor node data can be buffered in the memory cell array 280 of the non-volatile memory 230 until the set of root and neighbor node data can be written to the volatile memory 220.

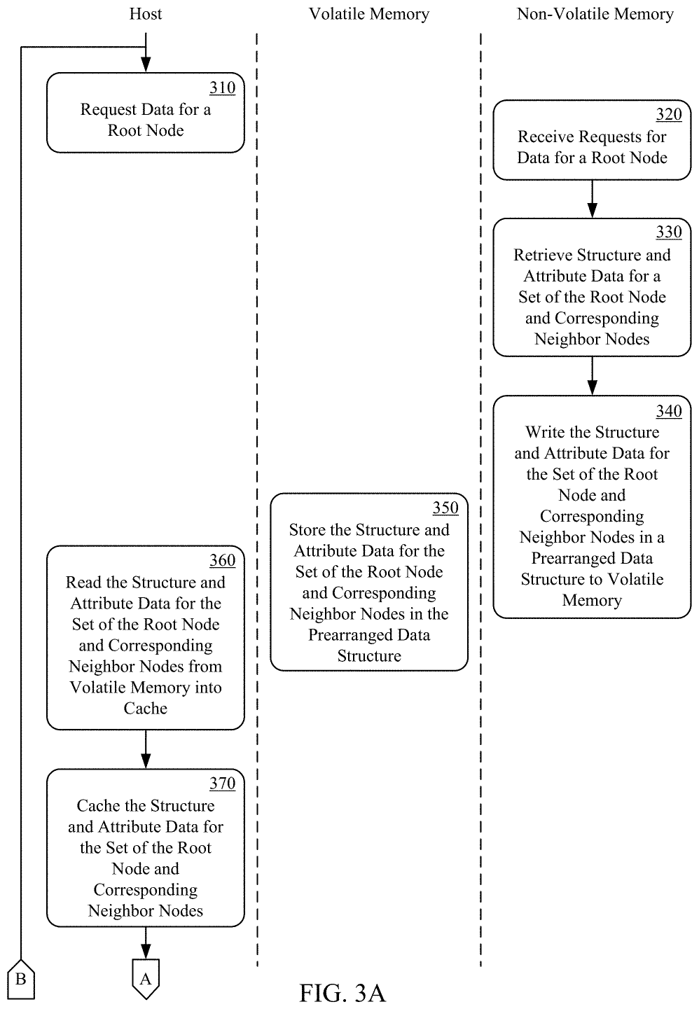

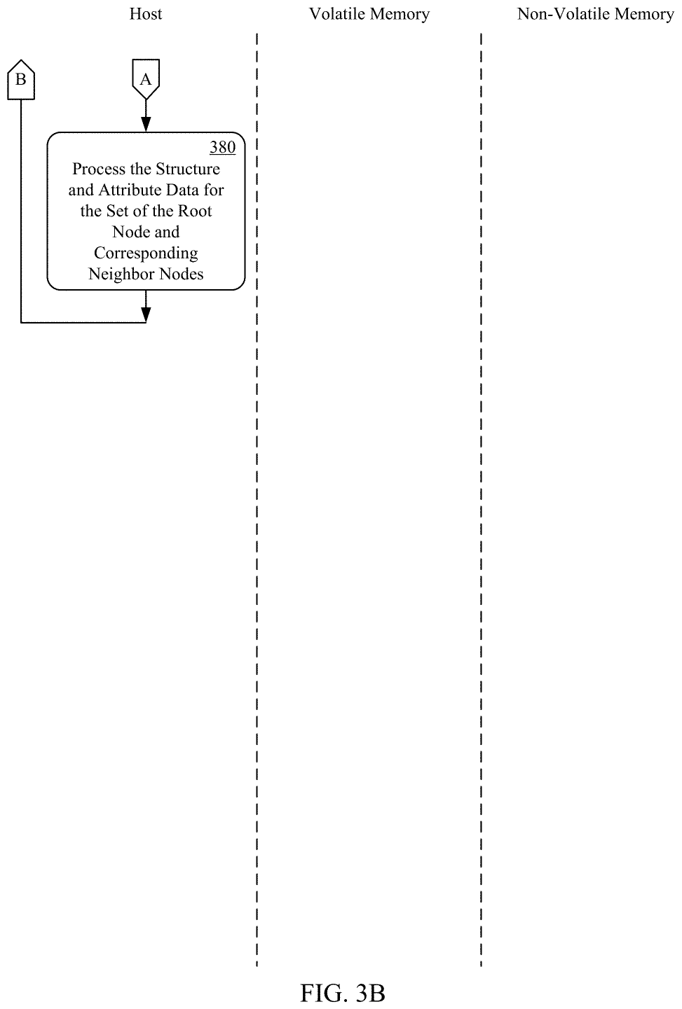

Operation of the graph neural network (GNN) processing system in accordance with aspects of the present technology will be further explained with reference to FIGS. 3A and 3B, which show a memory hierarchy method for graph neural network processing. The memory hierarchy method for graph neural network processing can include sending a request for data for a root node from the host 210 to the non-volatile memory 220, at 310. In one implementation, the node prefetch control unit 250 of the host 210 can generate a request for data related to a given root node and send the request across one or more communication links 240 to the node pre-arrange control unit 270 of the non-volatile memory 230. At 320, the request for data for a root node can be received by the non-volatile memory 220 from the host 210.

At 330, structure data and attribute data for a set including the requested root node and corresponding neighbor nodes of the requested root node can be retrieved. In one implementation, the node pre-arrange control unit 270 of the non-volatile memory 230 can retrieve structure and attribute data for the set of the root node and corresponding neighbor nodes from one or more memory cell arrays 280 of the non-volatile memory 230. At 340, the structure and attribute data for the set of the root node and corresponding neighbor nodes can be written from the non-volatile memory 230 to the volatile memory 220. In one implementation, the node pre-arrange control unit 270 can write the structure data and attribute data for a set including the requested root node and corresponding neighbor nodes to the volatile memory 220. At 350, the volatile memory 220 can store the structure and attribute data for the set of the root node and corresponding neighbor nodes in a prearranged data structure. In one implementation, the prearranged data structure can include a first portion of the volatile memory for storing the root node and neighbor node numbers and a second portion including the attribute data of the corresponding nodes. In one implementation, the set of the given root node and corresponding neighbor nodes and corresponding attribute data can be stored in one or more pages in the prearranged data structure.

At 360, the host 210 can read the structure and attribute data for the set of the root node and corresponding neighbor nodes from the volatile memory 220. In one implementation, the structure data and attribute data for the set including the root node and corresponding neighbor nodes for a current to be processed root node can be read from the volatile memory 220 into the host 210. At 370, the structure and attribute data for the set of the root node and corresponding neighbor nodes can be held in the cache 260 of the host 210. At 380, the structure and attribute data for the set of the root node and corresponding neighbor nodes for a current root node can be processed. In one implementation, one or more processes can be performed on the structure data and attribute data for the set including the root node and corresponding neighbor nodes of a current root node by the host 210 in accordance with and application such as but not limited to online shopping engines, social networking, knowledge graphs, recommendation engines, mapping engines, failure analysis, network management, life science, and search engines. The processes at 310-380 can be repeated for each of a plurality of root nodes to be processed by the host 210.

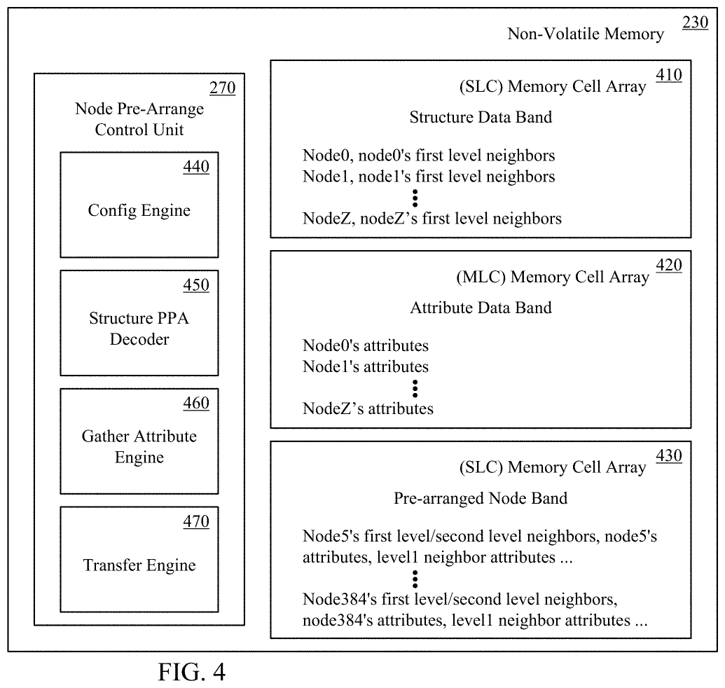

Referring now to FIG. 4, a non-volatile memory of a graph neural network (GNN) processing system, in accordance with aspects of the present technology, is shown. As described above, the non-volatile memory 230 can include one or more memory cell arrays 410-430 and a node pre-arrange control unit 270. The node-pre-arrange control unit 270 can include a configuration engine 440, a structure physical page address (PPA) decoder 450, a gather attribute engine 460 and a transfer engine 470. The configuration engine 440, the structure physical page address (PPA) decoder 450, the gather attribute engine 460, and the transfer engine 470 can be implemented by a state machine, embedded controller and or the like. In one implementation, graph data can include a structure data band and an attribute data band. The structure data band can include identifying data concerning each node, and the neighbor nodes in one or more levels for each given node. The attribute data band can include attribute data for each node. In one implementation, the structure data band can be stored in a single level cell (SLC) memory array 410, and the attribute data band can be stored in a multilevel cell (MLC) memory array 420. The SLC memory array 410, which is characterized by relatively faster read/write speeds but lower memory capacity, can be utilized to store structure data which typically accounts for approximately 10-30% of the total graph data. The MLC memory array 420, which is characterized by relatively slower read/write speed but higher memory capacity, can be utilized to store attribute data which typically accounts for approximately 90-70% of the total graph data.

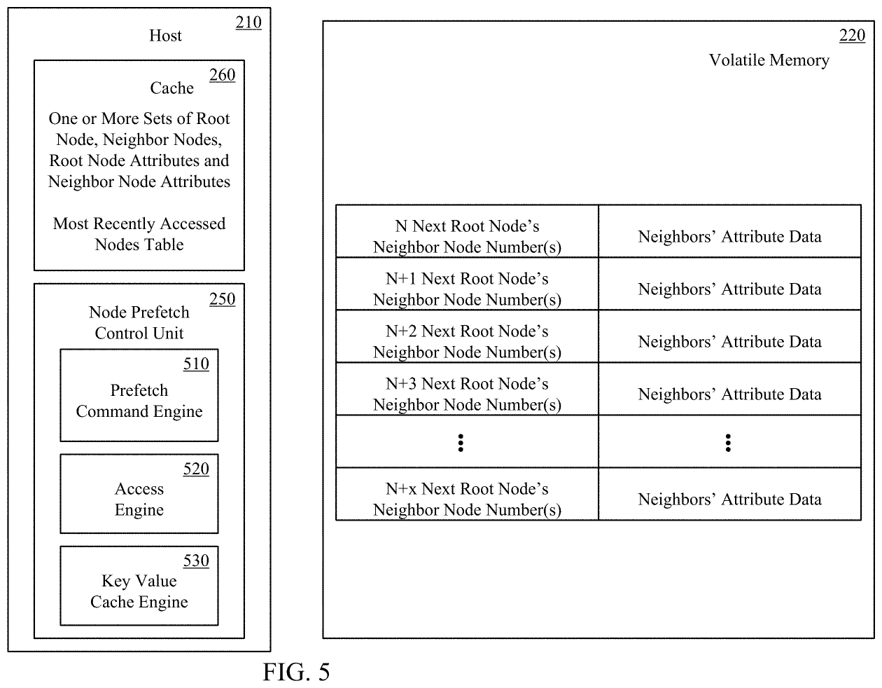

Referring now to FIG. 5, host and volatile memory of a graph neural network (GNN) processing system, in accordance with aspects of the present technology, is shown. As described above, the host 210 can include a node prefetch control unit 250 and a cache 260. The node prefetch control unit 250 can include a prefetch command engine 510, an access engine 520 and a key value cache engine 530. The prefetch command engine 510, the access engine 520 and the key value cache engine 530 can be implemented by a state machine, embedded controller and or the like. In one implementation, the prefetch command engine 510 can be configured to generate commands for sampling each of a plurality of nodes. Each command can identify a given node to pre-arrange. The prefetch command engine 510 can send the node sampling commands to the configuration engine 440 of the node pre-arrange control unit 270 of the non-volatile memory 230.

Referring again to FIG. 4, the configuration engine 440 can receive the node sampling commands for sampling each of a plurality of nodes. The configuration engine 440 can sample the structure data and the attribute data to determine the attributes for the given node of the command and the neighbor nodes at one or more levels of the graph data. The structure PPA decoder 450 can be configured to determine the physical address of neighbor nodes in the attribute data band in one or more levels of the graph data from the node numbers of the corresponding nodes. The gather attribute engine 460 can be configured to read the root and neighbor node numbers and their attributes at the determined physical address and pack them for storage in a block of volatile memory. For example, the gather attribute engine 460 can sample the first level neighbors of the root node. From the first level neighbors, the gather attribute engine 460 can also sample the second level neighbors, and so on for a predetermined number of levels of neighbors. The gather attribute engine 460 can then gather the corresponding attribute for the root node and the corresponding neighbor nodes of the predetermined number of levels. In an exemplary implementation, one attribute can include 128 elements that are each 32 bits and comprises 512 bytes of data. The 512 bytes of data can be the size of one logical block address (LBA). Eight attributes can be combined into one block of 4 kilobytes, and 32 attributes can fit in one page of 16 kilobytes. Accordingly, in such an implementation, two levels of graph neural network (GNN) neighbors can have on average 25 neighbors in total, so one page can fit all the attributes. However, if the two levels of neighbors include more than 25 neighbors, additional pages can be utilized. Accordingly, the data for a set of the root and neighbor nodes and the corresponding attributes can start on a new page for each different root node. The transfer engine 470 can be configured to store the packed set of root and neighbor node numbers and their attributes in a given block of volatile memory 220. If the volatile memory 220 is current full, the transfer engine 470 can optionally write packed sets of root and neighbor node numbers and their attributes to a pre-arranged node band in the non-volatile memory 230. In one implementation, the pre-arranged node band can be stored in a single level cell (SLC) memory array 430. The configuration engine 440 can also be configured to send an indication of completion of each node sampling command back to the host 210.

Referring again to FIG. 5, the access engine 520 can be configured to load the packed set of root and neighbor node numbers and their attributes in a given block of volatile memory 220. The access engine 520 can also be configured to read a set of a next root node and corresponding neighbor nodes, and corresponding attributes from the volatile memory into the cache 260 for processing by the host 210. The prefetch command unit 510 can receive the indication of completion of each sampling from the configuration engine 440 of the node pre-arrange control unit 270. The prefetch command unit 510 can continue to send commands for sampling additional nodes as long as the volatile memory 220 is not full. The key value cache engine 530 can be configured to maintain a table of most recently accessed nodes. In one implementation, the information can include a table with keys set to be node numbers, and the values set to the node's attributes. The table can then be checked to see if the cache 260 already has the data for the given node. The table can also be utilized to evict the least recently used set of root and neighbor nodes and the corresponding attributes to make room for a new set of root and neighbor nodes and the corresponding attributes in the cache 260.

In accordance with aspects of the present technology, the volatile memory can advantageously hold sets of root and neighbor nodes and the corresponding attributes for a number of next root nodes to be processed by the host. Furthermore, the sets of root and neighbor nodes and the corresponding attributes are prepared in the volatile memory and therefore can advantageously be sequentially accessed, thereby improving the read bandwidth of the non-volatile memory. Aspects of the present technology advantageously allow node information to be loaded from the high-capacity non-volatile memory, into the volatile memory, and then into the cache of the host, which can save time and power. Storing the graph data in non-volatile memory, and just a plurality of sets of next root and neighbor nodes and the corresponding attributes in volatile memory, can also advantageously reduce the cost of the system, because non-volatile memory can typically be approximately 20 times cheaper than volatile memory. Storing the graph data in non-volatile memory as compared to the volatile memory can also advantageously save power because non-volatile memory does not need to be refreshed. The large capacity of non-volatile memory can also advantageously enable the entire graph data to be stored. Increased performance can also be achieved by near data processing with less data movement, where node sampling is advantageously accomplished in the non-volatile memory and then prefetched to the volatile memory and then cached in accordance with aspects of the present technology.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is intended that the scope of the invention be defined by the claims appended hereto and their equivalents.

What is claimed is:

1. A computing system for processing graph data including root nodes and neighbor nodes, the computing system comprising:
a volatile memory;
a host communicatively coupled to the volatile memory, the host including a prefetch control unit configured to request data for a plurality root nodes of the graph data; and
a non-volatile memory communicatively coupled to the host and the volatile memory, wherein the non-volatile memory is configured to store the graph data, and wherein the non-volatile memory includes a node pre-arrange control unit configured to retrieve sets of root and neighbor nodes and corresponding attributes from the graph data in response to the corresponding requests for the plurality of root nodes and to write the retrieved sets of root and neighbor nodes and corresponding attributes to the volatile memory in a prearranged data structure.

2. The computing system of claim 1, wherein the host further includes a cache configured to store a current one of the sets of root and neighbor node data from the volatile memory for processing by the host.

3. The computing system of claim 1, wherein the non-volatile memory is further configured to buffer one or more of the sets of the root and neighbor nodes before writing to the volatile memory.

4. The computing system of claim 1, wherein the non-volatile memory is further configured to store the graph data as structure data in a single level cell (SLC) memory array and attribute data in a multilevel cell (MLC) memory array.

5. The computing system of claim 1, wherein the prefetch control unit includes a prefetch command engine configured to generate node sampling commands for each of a plurality of nodes.

6. The computing system of claim 5, wherein the prefetch control unit further includes an access engine configured to load a packed set of root and neighbor node numbers and their attributes in a given block of volatile memory and to read a next set of root node, neighbor nodes and corresponding attributes from the volatile memory into cache.

7. The computing system of claim 5, wherein the prefetch control unit further includes a key value cache engine configured to maintain a table of most recently accessed nodes.

8. The computing system of claim 1, wherein the node pre-arrange control unit includes a configuration engine configured to sample structure data and attribute data to determine attributes for a given node of a node sampling command.

9. The computing system of claim 8, wherein the node pre-arrange control unit further includes a structure physical page address decoder configured to determine physical addresses of neighbor nodes.

10. The computing system of claim 8, wherein the node pre-arrange control unit further includes a gather scatter engine configured to sample one or more levels of neighbor nodes and gather corresponding attributes.

11. The computing system of claim 8, wherein the node pre-arrange control unit further includes a transfer engine configured to store a packed set including the root node and neighbor nodes and corresponding attributes.

12. A memory hierarchy method for graph neural network processing comprising:
requesting, by a host, data for a root node;
retrieving, by a non-volatile memory, structure and attribute data for a set of graph data including the root node and corresponding neighbor nodes of the root node;
writing, by the non-volatile memory, the structure and attribute data for the set of graph data including the root node and corresponding neighbor nodes to volatile memory in a prearranged data structure;
reading, by the host, the structure and attribute data for the set of graph data including the root node and corresponding neighbor nodes from the volatile memory into a cache of the host; and
processing, by the host, the structure and attribute data for the set of graph data including the root node and corresponding neighbor nodes.

13. The memory hierarchy method for graph neural network processing according to claim 12, further comprising buffering, by the non-volatile memory, the structure and attribute data for the set of graph data including the root node and corresponding neighbor nodes in the non-volatile memory when the volatile memory is full.

14. The memory hierarchy method for graph neural network processing according to claim 12, further comprising:
caching, by the host, the structure and attribute data for the set of graph data including the root node and corresponding neighbor nodes;
maintaining, by the host, information about recently accessed nodes; and
processing, by the host, the structure and attribute data for the set of graph data including the root node and corresponding neighbor nodes from the cache based on the information about recently accessed nodes.

15. The memory hierarchy method for graph neural network processing according to claim 12, further comprising:
storing structure data of the graph data in a single level cell memory array of the non-volatile memory; and
storing attribute data of the graph data in a multilevel cell memory array of the non-volatile memory.

16. The memory hierarchy method for graph neural network processing according to claim 12, wherein the prearranged data structure in the volatile memory includes a first portion including root node and neighbor node numbers and a second portion including attribute data.

17. The memory hierarchy method for graph neural network processing according to claim 12, wherein the prearranged data structure in the volatile memory includes one or more pages including the structure data including root node and neighbor node numbers and the attribute data.
